(19) United States
(12) Patent Application Publication
(10) Pub. No.: US 2015/0268411 A1
(43) Pub. Date: Sep. 24, 2015

(54) FRAME STRUCTURE AND BACKLIGHT MODULE

(71) Applicant: Radiant Opto-Electronics Corporation, Kaohsiung (TW)

(72) Inventors: Jia-Rong HU, KAOHSIUNG (TW); Pei-Ling KAO, KAOHSIUNG (TW); Chun-Hsien LI, KAOHSIUNG (TW)

(21) Appl. No.: 14/320,779

(22) Filed: Jul. 1, 2014

(30) Foreign Application Priority Data
Mar. 19, 2014 (TW) 103110331

(51) Int. Cl. F21V 8/00

(52) U.S. Cl. CPC G02B 6/0088; G02B 6/0031

(57) ABSTRACT

A frame structure and a backlight module are provided. The frame structure includes a frame body and a reflecting structure. The frame structure includes a frame body and a reflecting structure. The reflecting structure is disposed inside the frame body. The reflecting structure includes a first portion and a second portion. The first portion is connected to the frame body. The second portion has elasticity and is elastically separated from the frame body.

### RELATED APPLICATIONS

This application claims priority to Taiwan Application Serial Number 103110331, filed Mar. 19, 2014, which is herein incorporated by reference.

### BACKGROUND

1. Field of Invention

The present invention relates to a light source assembly. More particularly, the present invention relates to a frame structure and a backlight module.

### DESCRIPTION OF RELATED ART

Referring to FIG. 1A and FIG. 1B, FIG. 1A and FIG. 1B are schematic structural diagrams showing an assembling process of a conventional backlight module 100. In order to fix a light bar 150 and a light guide plate 170, a carrying frame 130 generally disposed on a back plate 110 of the conventional backlight module 100. The carrying frame 130 has a C-like structure 130a formed on its one side, and the C-like structure 130a has accommodation space for receiving a light bar. Therefore, as shown in FIG. 1A, after a double sides adhesive tape is attached to a back side of the light bar 150, the light bar 150 has to be inserted into the accommodation space from one end of the C-like structure 130a and is adhered to the C-like structure 130a through the double faced adhesive tape. After the light bar 150 is fixed on the C-like structure 130a, the carrying frame 130 can be directly disposed on the back plate 110. Thereafter, as shown in FIG. 1B, the light guide plate 170 is inserted into the C-like structure 130a of the carrying frame 130 inclinedly, thereby fixing the light guide plate 170 on the carrying frame 130.

However, the process for fabricating such a carrying frame 130 is relatively difficult and expensive, and the aforementioned conventional assembling process has many shortcomings. When inserting the light bar 150 into the accommodation space of the carrying frame 130, an assembler is not able to see the actual location of the light bar 150 directly, and thus fails to fix the light bar 150 to the correct position at the C-like structure 130a. If the light bar 150 is not be placed at the correct position, it often results in a light-incident surface of the light guide plate 170 disposed on the carrying frame 130 failing to effectively align with the light bar 150, thus seriously affecting the optical effect of the backlight module 100. Furthermore, the carrying frame 130 is likely to scratch the light guide plate 170 during the assembling process in which the light guide plate 170 is inserted into the carrying frame 130 inclinedly, thus seriously affecting the yield of the backlight module 100.

### SUMMARY

One aspect of the present invention is to provide a frame structure and a backlight module, in which a reflecting structure assembled on a frame body can be applied to change the overall assembling process of the backlight module. Therefore, when assembling the backlight module, an assembler may directly see the relative position between a light source and a light guide plate of the backlight module, and can ensure the light source to be aligned with a light-incident surface of the light guide plate, thus improving the yield of the backlight module. Furthermore, the reflecting structure may replace the conventional carrying frame. Because the fabrication of the reflecting structure is simple and low cost, the manufacturing cost of the backlight module is greatly reduced. Moreover, the reflecting structure can directly reflect the light near the light-incident surface of the light guide plate back to the light guide plate, thus increasing light use efficiency and improving optical appearance of the backlight module.

According to the aforementioned objects, a frame structure is provided. The frame structure includes a frame body and a reflecting structure. The reflecting structure is disposed inside the frame body. The reflecting structure includes a first portion and a second portion. The first portion is connected to the frame body. The second portion has elasticity and is elastically separated from the frame body.

According to an embodiment of the present invention, the second portion and the first portion are at different elevations, and the reflecting structure further includes a third portion connecting the first portion and the second portion, in which a first angle is included between the third portion and the first portion, and a second angle is included between the third portion and the second portion.

According to an embodiment of the present invention, the frame structure further includes a fixing structure combining the reflecting structure with the frame body.

According to an embodiment of the present invention, the fixing structure further includes at least one extending portion and at least one opening portion corresponding to the extending portion, in which the extending portion is disposed on the first portion, and the opening portion is disposed on the frame body.

According to an embodiment of the present invention, the extending portion has a rounded corner.

According to an embodiment of the present invention, the fixing structure includes plural positioning posts and plural penetrating hole portions corresponding to the positioning posts, in which the positioning posts are disposed on one of the first potion and the frame, and the penetrating hole portions are disposed on the other one of the first potion and the frame.

According to an embodiment of the present invention, the reflecting structure further includes plural microstructures respectively disposed on a surface of the first portion, a surface of the second portion and a surface of the third portion.

According to an embodiment of the present invention, the first angle is substantially equal to the second angle.

According to an embodiment of the present invention, a backlight module is provided. The backlight module includes a back plate, a light guide plate, a light source, a frame body and a reflecting structure. The light guide plate is disposed on the back plate. The light source is disposed on the back plate and is adjacent to the light guide plate. The frame body is adapted to be disposed above the back plate. The reflecting structure is disposed inside the frame body and covers the light source, in which the reflecting structure includes a first portion and a second portion. The first portion is connected to the frame body. The second portion is elastically separated from the frame body such that the second portion resiliently recovers and abuts against the light guide plate by elastic force.

According to an embodiment of the present invention, the second portion and the first portion are at different elevations. The reflecting structure further includes a third portion connecting the first portion and the second portion, in which a first angle is included between the third portion and the first portion, and a second angle is included between the third portion and the second portion.

According to an embodiment of the present invention, the backlight module further includes a fixing structure combining the reflecting structure with the frame body.

According to an embodiment of the present invention, the light guide plate includes a light-incident surface, and the second portion of the reflecting structure abuts against the light guide plate near the light-incident surface.

According to an embodiment of the present invention, the second portion of the reflecting structure has a reflecting surface.

According to an embodiment of the present invention, the frame body is movable in an unassembled state along a first direction to be disposed above the back plate in an assembled state, and the reflecting structure is movable in an unassembled state along a second direction to be disposed inside the frame body in an assembled state.

According to an embodiment of the present invention, the frame body is moveable in an unassembled state along a first direction until the reflecting structure disposed on the frame body abuts against the light guide plate in an assembled state.

According to an embodiment of the present invention, the fixing structure further includes at least one extending portion and at least one opening portion corresponding to the extending portion, in which the extending portion is disposed on the first portion, and the opening portion is disposed on the frame body.

According to an embodiment of the present invention, the extending portion has a rounded corner.

According to an embodiment of the present invention, the fixing structure includes plural positioning posts and plural hole portions corresponding to the positioning posts, in which the positioning posts are disposed on one of the first potion and the frame, and the hole portions are disposed on the other one of the first potion and the frame.

According to an embodiment of the present invention, the reflecting structure further includes plural microstructures respectively disposed on a surface of the first portion, a surface of the second portion and a surface of the third portion.

According to an embodiment of the present invention, the first angle is substantially equal to the second angle.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A and FIG. 1B are schematic structural diagrams showing an assembling process of a conventional backlight module;

FIG. 2A is a schematic structural diagram showing a backlight module in accordance with an embodiment of the present invention;

FIG. 2B is a schematic side view of a backlight module in accordance with an embodiment of the present invention;

FIG. 3 is schematic exploded view showing a frame structure in accordance with an embodiment of the present invention;

FIG. 4 is a schematic side view of a reflecting structure in accordance with an embodiment of the present invention;

FIG. 5 is a schematic side view of another reflecting structure in accordance with an embodiment of the present invention;

FIG. 6 is a schematic top view of another reflecting structure in accordance with an embodiment of the present invention;

FIG. 7 is a schematic cross-sectional view of another backlight module in accordance with an embodiment of the present invention; and

FIG. 8A-FIG. 8D are schematic structural diagrams showing an assembling process of a backlight module in accordance with an embodiment of the present invention.

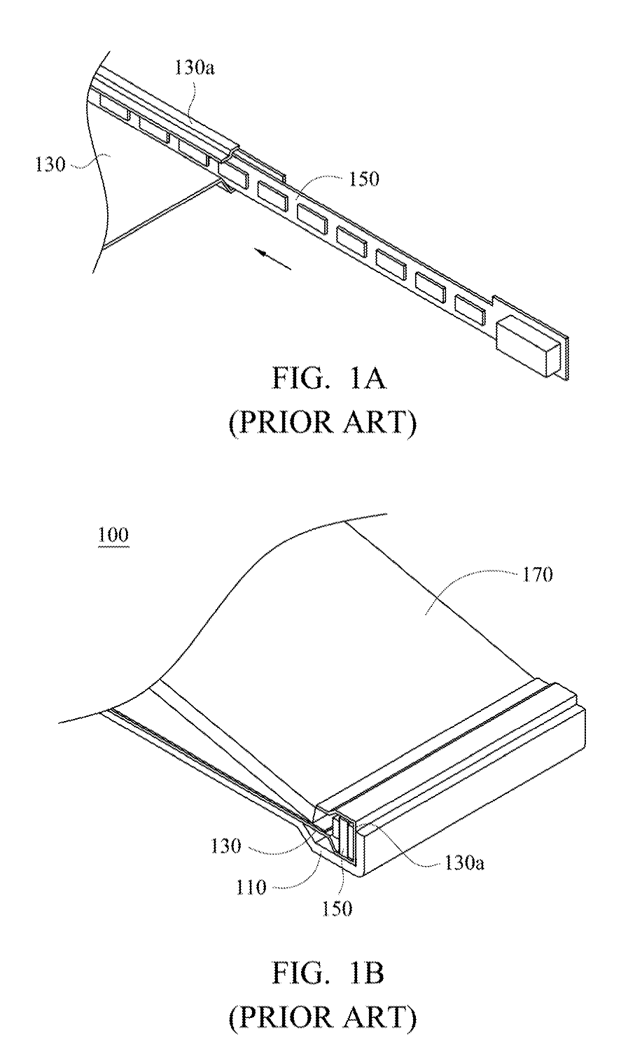

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

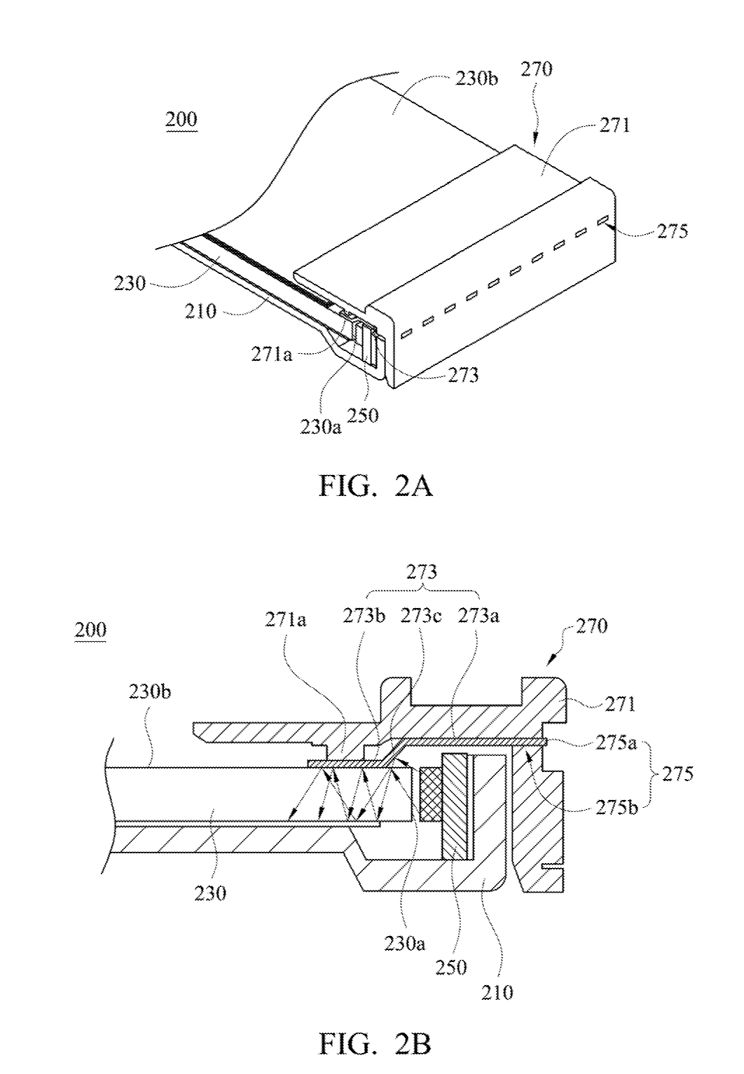

Simultaneously referring to FIG. 2A and FIG. 2B, FIG. 2A and FIG. 2B are a schematic structural diagram and a schematic side view showing a backlight module 200 in accordance with an embodiment of the present invention. The backlight module 200 mainly includes a back plate 210, a light guide plate 230, a light source 250 and a frame structure 270. The light guide plate 230, the light source 250 and the frame structure 270 are disposed on the back plate 210. The light source 250 is adjacent to a light-incident surface 230a of the light guide plate 230 to emit light to ward's the light guide plate 230. The light guide plate 230 can guide the light generated by the light source 250 to be uniformly emitted from a light-emitting surface 230b of the light guide plate 230. In some examples, the light source 250 may be a light bar or a cold cathode fluorescent lamp (CCFL).

In some embodiments, the frame structure 270 includes a frame body 271, a reflecting structure 273 and a fixing structure 275. The frame body 271 is adapted to be fixed on the back plate 210 for holding a liquid crystal panel. The reflecting structure 273 can be combined with the frame body 271 through the fixing structure 275. The reflecting structure 273 is used to reflect light generated by the light source 250 back to the light guide plate 230, so as to increase light use efficiency. In one embodiment, the reflecting structure 273 is made of metal or reflective material of nonmetal. Moreover the thickness of the reflecting structure 273 can be designed according to elastic modulus of different materials.

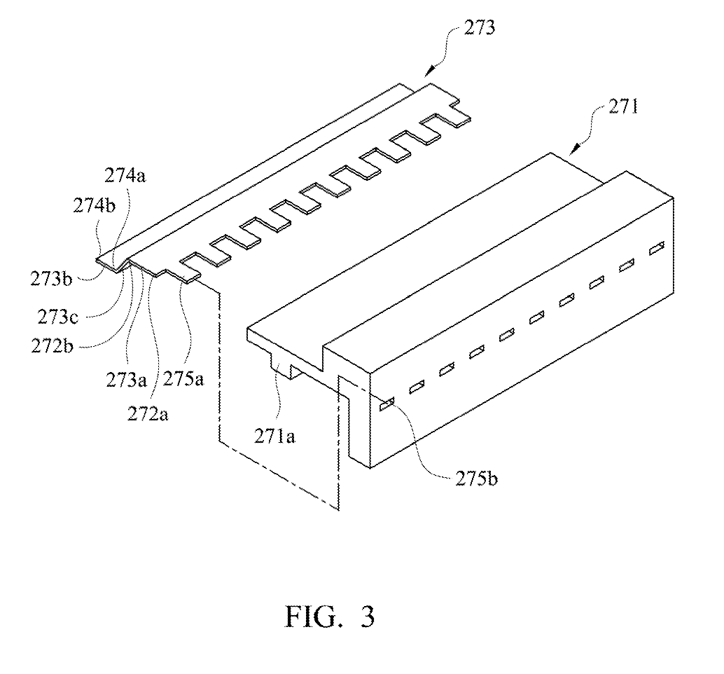

Referring to FIG. 2A, FIG. 2B and FIG. 3, FIG. 3 is a schematic exploded view showing a frame structure in accordance with an embodiment of the present invention. The reflecting structure 273 is formed in a step shape and includes a first portion 273a, a second portion 273b and a third portion 273c. The first portion 273a includes a first side 272a and a second side 272b opposite to each other, and the second portion 273b includes a first side 274a and a second side 274b opposite to each other. Meanwhile, the first portion 273a and the second portion 273b are at different elevations. In some embodiments, the third portion 273c is an inclined plane. One side of the third portion 273c is connected to the second side 272b of the first portion 273a, and the other side is connected to the first side 274a of the second portion 273b. In other words, the third portion 273c is located between the first portion 273a and the second portion 273b.

As shown in FIG. 2B, when the reflecting structure 273 is disposed on the frame body 271 combined with the back plate 210, the first portion 273a of the reflecting structure 273 is fixed on the frame body 271, and the second portion 273b abuts against the light-emitting surface 230b of the light guide plate 230 near the light-incident surface 230a, so as to fix the light guide plate 230. It is noted that, the second portion 273b of the reflecting structure 273 has elasticity, which is elastically separated from the frame body 271. Therefore,while the frame body 271 is combined with the back plate 210, the second portion 273b of the reflecting structure 273 is initially deformed towards the frame body 271 and then resiliently recovers and abuts against the light guide plate 230 by elastic force. In addition, the third portion 273c located between the first portion 273a and the second portion 273b can reflect light generated by the light source 250 back to the light guide plate 230.

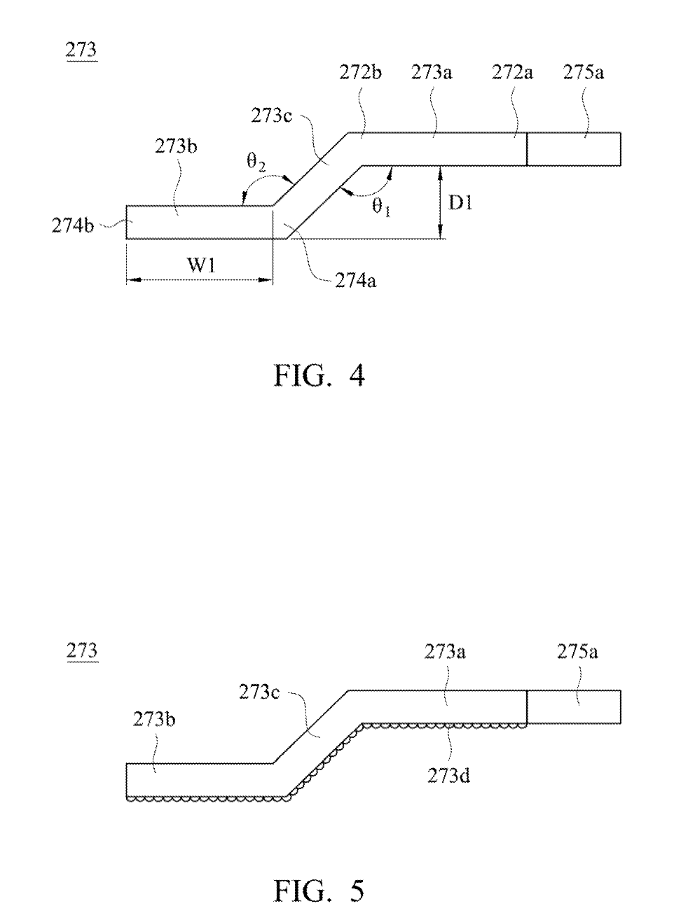

Simultaneously referring to FIG. 2B and FIG. 4, FIG. 4 is a schematic side view of a reflecting structure in accordance with an embodiment of the present invention. In the present embodiment, a first angle θ₁ is included between the third portion 273c of the reflecting structure 273 and the first portion 273a, and a second angle θ₂ is included between the third portion 273c and the second portion 273a. The degree of inclination of the third portion 273c can be adjusted by changing the first angle θ₁ and the second angle θ₂, so as to reflect light emitted towards the reflecting structure 273 back to the light guide plate 230, thereby increasing light use efficiency. In one embodiment, the first angle θ₁ is substantially equal to the second angle θ₂. In the present embodiment, the first portion 273a and the second portion 273b are flat planes, and the first portion 273a and the second portion 273b are at different elevations. Therefore, when the first angle θ₁ is equal to the second angle θ₂, the first portion 273a is parallel to the second portion 273b.

Referring to FIG. 2B and FIG. 4, the second portion 273b of the reflecting structure 273 has a width W1, and covers a portion of the light guide plate 230 near the light-incident surface 230a. When the light generated by the light source 250 enters the light guide plate 230 from the light-incident surface 230a, the light emitted towards the second portion 273b can be reflected back to the light guide plate 230 by the second portion 273b, thereby preventing hotspots from being generated. Moreover, the width W1 can be designed according to the intensity of the light source 250, the size of the backlight module 200 or other structural requirements.

On the other hand, a perpendicular distance D1 between the first portion 273a and the second portion 273b is designed according to a distance between the frame body 271 and the light guide plate 230, so as to enable the second portion 273b to abut against the light guide plate 230, thereby preventing the light leakage problem. As shown in FIG. 2A and FIG. 2B, in one embodiment, the frame body 271 further includes a convex rib 271a. When the reflecting structure 273 is disposed on the frame body 271, the convex rib 271a abuts against the second portion 273a. Accordingly, when the frame structure 270 is disposed on the back plate 210, the convex rib 271a abuts against the light guide plate 230.

In the present invention, the reflecting structure 273 may have different designs from the aforementioned embodiments. Referring to FIG. 5, FIG. 5 is a schematic side view of another reflecting structure in accordance with an embodiment of the present invention. In some embodiments, the reflecting structure 273 further includes plural microstructures 273d. The microstructures 273d are respectively disposed on a surface of the first portion 273a, a surface of the second portion 273b and a surface of the third portion 273c, in which the surface of the first portion 273a, the surface of the second portion 273b and the surface of the third portion 273c are at the same side of the reflecting structure 273. In some embodiments, the microstructures 273d are V-shaped microstructures, R-shaped microstructures, or a rough surface or a patterned surface disposed on the first portion 273a, the second portion 273b and the third portion 273c.

Referring to FIG. 2B and FIG. 3, in one embodiment, the fixing structure 275 includes at least one extending portion 275a and at least one opening portion 275b corresponding to the extending portion 275a. Moreover the extending portion 275a is disposed on the reflecting structure 273, and the opening portion 275b is disposed on the frame body 271. As shown in the embodiment of FIG. 2 and FIG. 3, the extending portion 275a includes plural finger-like structures extending from the first side 272a of the first portion 273a of the reflecting structure 273. The opening portion 275b are plural openings corresponding to the finger-like structures, in which the openings penetrate through the frame body 271. Accordingly, the reflecting structure 273 can be fixed on the frame body 271 by inserting the extending portion 275a into the opening portion 275b.

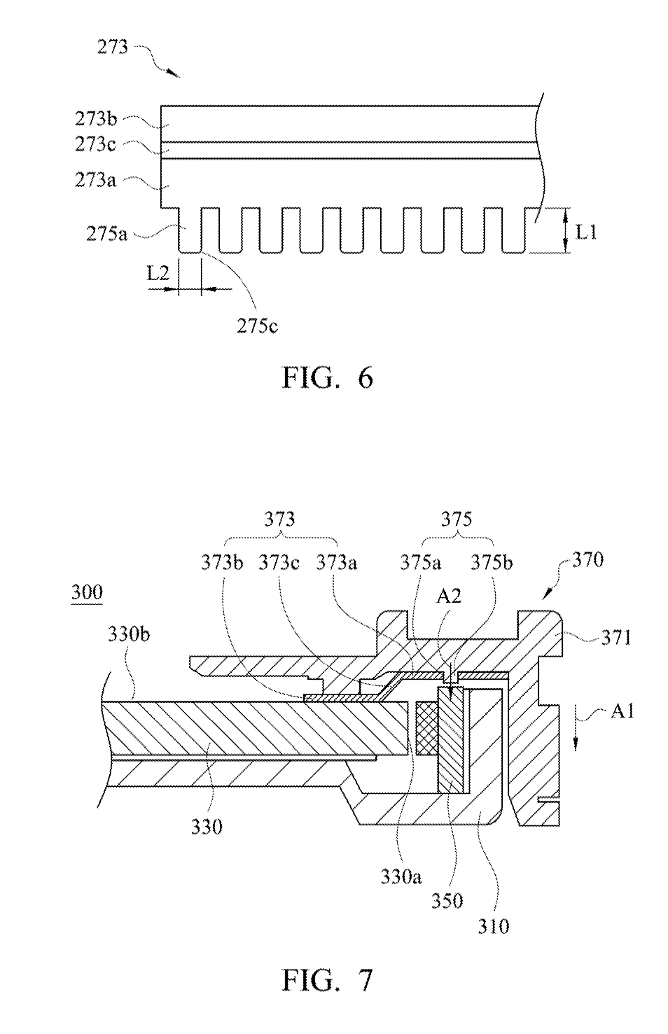

Simultaneously referring to FIG. 6, FIG. 6 is a schematic top view of another reflecting structure in accordance with an embodiment of the present invention. In the present embodiment, the extending portion 275a has a first length L1 and a second length L2. Furthermore, the size of the opening portion 275b is designed according to the first length L1 and the second length L2, so as to enable the opening portion 275b to be tightly fit to the extending portion 275a. In addition, the combining strength between the extending portion 275a and the opening portion 275b can be increased by changing the first length L1 and the second length L2. As shown in FIG. 6, in one embodiment, the extending portion 275a has a rounded corner 275c, which can prevent a scratch problem from occurring when the extending portion 275a is being inserted into the opening portion 275b.

Referring to FIG. 7, FIG. 7 is a schematic cross-sectional view of another backlight module 300 in accordance with an embodiment of the present invention. The backlight module 300 includes a back plate 310, a light guide plate 330, light source 350 and a frame body 370. The light guide plate 330, the light source 350 and the frame body 370 are disposed on the back plate 310. The light source 350 is adjacent to a light-incident surface 330a of the light guide plate 330 to emit light towards the light guide plate 330. Similarly, the light guide plate 330 can guide the light generated by the light source 350 to be uniformly emitted from a light-emitting surface 330b of the light guide plate 330.

As shown in FIG. 7, in the present embodiment, the frame structure 370 includes a frame body 371, a reflecting structure 373 and a fixing structure 375. The reflecting structure 373 includes a first portion 373a, a second portion 373b and a third portion 373c. It is noted that the reflecting structure 273 shown in FIG. 2B and FIG. 3 is fixed on the frame body 271 by inserting the extending portion 275a into the opening portion 275b. In the present embodiment, the fixing structure 375 includes penetrating hole portions 375a and positioning posts 375b. The penetrating hole portions 375a are disposed on the first portion 373a of the reflecting structure 373, and the positioning posts 375b are disposed on the frame body 371. Moreover, the position of the penetrating hole portions 375a are located corresponding to the position of the positioning posts 375b. Accordingly, the reflecting structure 373 can be fixed on the frame body 371 by inserting the positioning posts 375b into the penetrating hole portions 375a along a direction A2, in which the “direction A2” stands for a direction vertical to the reflecting structure 373. In other words, the reflecting structure 373 is movable in an unassembled state along the direction A2 to be disposed inside the frame body 371 in an assembled state. Moreover, the frame body 370 is movable in an unassembled state along a direction A1 to be disposed above the back plate 310 in an assembled state, in which the “direction A1” stands for a direction vertical to the back plate 310. In the present embodiment, the direction A1 is parallel to the direction A2.

It is noted that, in the embodiment as shown in FIG. 7, the penetrating hole portions 375a disposed on the first portion 373a of the reflecting structure 373, and the positioning posts 375b disposed on the frame body 371, are merely used as an example for explanation and embodiments of the present invention is not limited thereto. In other embodiments, the penetrating hole portions 375a can be disposed on the frame body 317, and the positioning posts 375b can be disposed on the first portion 373a of the reflecting structure 373.

It is noted that in the embodiment shown in FIG. 2B, the reflecting structure 273 and the frame body 271 are combined together by using the fixing structure 275. In other embodiments, besides the fixing structure 275, the reflecting structure 273 can be additionally implemented with the fixing structure 375 as shown in FIG. 7. In other words, the reflecting structure 273 is implemented with both the extending portion 275a and the penetrating hole portions 375a, and the frame body 271 is implemented with both the opening portion 275b and positioning posts 375b. Accordingly, the reflecting structure 273 can be fixed and positioned on the frame body 271.

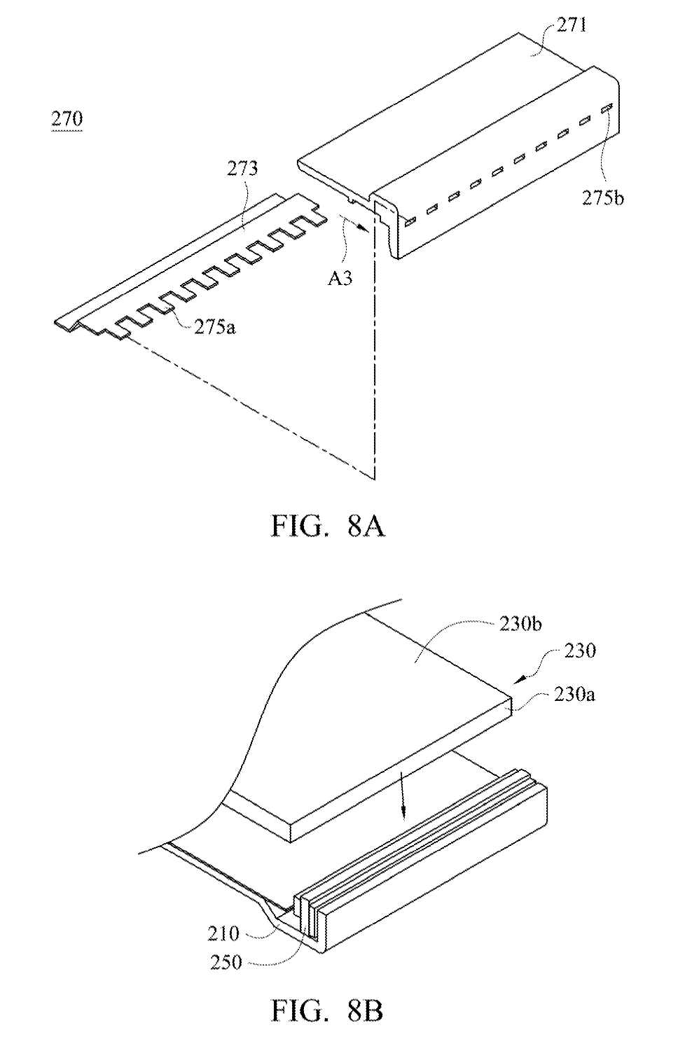

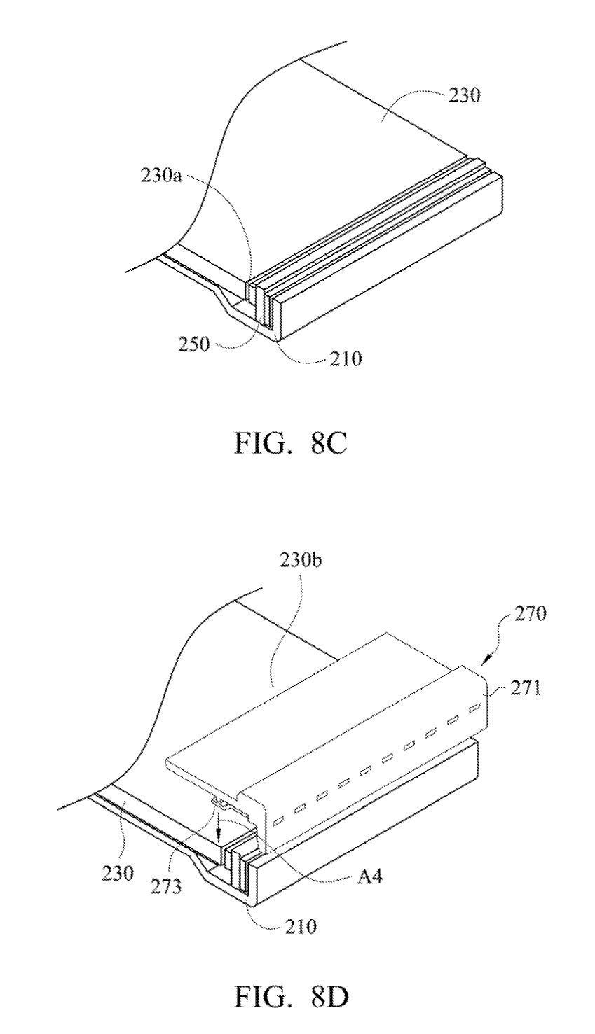

An assembling process of the backlight module 200 is described below. Simultaneously referring to FIG. 2 and FIG. 8A-FIG. 8D, FIG. 8A-FIG. 8D are schematic structural diagrams showing an assembling process of the backlight module 200 in accordance with an embodiment of the present invention. As shown in FIG. 8A, in the assembling process of the backlight nodule 200, the reflecting structure 273 is moved along a direction A3 to be disposed on an inner side of the frame body 271. More specifically, the extending portion 275a of the reflecting structure 273 in an unassembled state is inserted into the opening portion 275b of the frame body 271, so as to fix the reflecting structure 273 on the frame body 271 and complete the assembly of the frame structure 270 in an assembled state.

At the same time, as shown in FIG. 8B, the light source 250 is disposed on the back plate 210. Then, as shown in FIG. 8C, the light guide plate 230 is disposed on the back plate 210 and a light-emitting surface of the light source 250 is aligned with the light-incident surface 230a of the light guide plate 230. Thereafter, as shown in FIG. 8D, the frame body 271 is moved along a direction A4 to be disposed above the back plate 210 until the reflecting structure 273 disposed on the frame body 271 abuts against the light guide plate 230. More specifically, the assembled frame structure 270 is moved along a direction vertically downwards the back plate 210 to be disposed on the back plate 210, so as to fix on the back plate 210 and complete the assembly of the backlight module 200. In the present embodiment, the direction A3 is vertical to the direction A4. It is noted that the second portion 273b of the reflecting structure 273 has elasticity. While the frame structure 270 is fixed on the back plate 210, the second portion 273b firstly contacting the light guide plate 230 can be deformed towards the frame body 271 (i.e. opposite to the light-emitting surface 230b of the light guide plate 230), and the second portion 273b can resiliently recover and abut against the light guide plate 230 by elastic force, thus achieving an object of securing the light guide plate 230 firmly.

Referring to Table 1-Table 3, Table 1 shows the results of luminance and uniformity by respectively measuring thirteen points on a conventional backlight module, and Table 2 shows the results of luminance and uniformity by respectively measuring thirteen points on a backlight module having a plastic reflecting structure according to an embodiment of the present invention, and Table 3 shows the results of luminance and uniformity by respectively measuring thirteen points on a backlight module having a metal reflecting structure according to another embodiment of the present invention, in which the “thirteen points” are thirteen individual measurement points selected from twenty-five points equidistantly spaced on the backlight module. Further, the uniformity is the minimum luminance value of the thirteen points divided by the maximum luminance value of the thirteen points. For example, the uniformity of Table 1 is 3829/4549=84.17%.

TABLE 1
(the conventional backlight module)

| | | | | | central | | average |
|---|---|---|---|---|---|---|---|
| luminance at each point | | | | | luminance | uniformity | luminance |
| 3999 | | 4385 | | 3989 | 4549 | 84.17% | 4190 |
| | 4430 | | 4342 | | | | |
| 4219 | | 4549 | | 4036 | | | |
| | 4020 | | 3829 | | | | |
| 4305 | | 4155 | | 4207 | | | |

TABLE 2
(the backlight module having a plastic reflecting structure)

| | | | | | central | | average |
|---|---|---|---|---|---|---|---|
| luminance at each point | | | | | luminance | uniformity | luminance |
| 4047 | | 4586 | | 4175 | 4675 | 84.49% | 4305 |
| | 4560 | | 4507 | | | | |
| 4333 | | 4675 | | 4201 | | | |
| | 4132 | | 3950 | | | | |
| 4401 | | 4190 | | 4210 | | | |

TABLE 3
(the backlight module having a metal reflecting structure)

| | | | | | central | | average |
|---|---|---|---|---|---|---|---|
| luminance at each point | | | | | luminance | uniformity | luminance |
| 4114 | | 4497 | | 4095 | 4707 | 84.68% | 4306 |
| | 4543 | | 4490 | | | | |
| 4331 | | 4707 | | 4173 | | | |
| | 4105 | | 3986 | | | | |
| 4417 | | 4233 | | 4287 | | | |

It can be known from Table 1-Table 3 that, both the luminance of the backlight module having the metal reflecting structure and the luminance of the backlight module having the plastic reflecting structure are higher than the luminance of the conventional backlight module with no reflecting structure. Moreover, the central luminance of the conventional backlight module is 4549 nit, failing to meet the requirements of current industry which is 4600 nit. Therefore, the optical effect generated by the backlight module having, the reflecting structure is better than that generated by the conventional backlight module.

According to the aforementioned embodiments of the present invention, the reflecting structure assembled on the frame body can be applied to change the overall assembling process of the backlight module. Therefore, when assembling the backlight module, an assembler may directly see the relative position between the light source and the light guide plate, and can ensure the light source to be aligned with the light-incident surface of the light guide plate, thus improving the yield of the backlight module. Furthermore, the reflecting structure may replace the conventional carrying frame. Because the fabrication of the reflecting structure is simple and low cost, the manufacturing cost of the backlight module is greatly reduced. Moreover, the reflecting structure can directly reflect the light near the light-incident surface of the light guide plate back to the light guide plate, thus increasing light use efficiency and improving optical appearance of the backlight module.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A frame structure, comprising:
a frame body; and
a reflecting structure disposed inside the frame body, wherein the reflecting structure comprises:
a first portion connected to the frame body; and
a second portion which is elastically separated from the frame body.

2. The frame structure of claim 1, wherein the second portion and the first portion are at different elevations, and the reflecting structure further comprises a third portion connecting the first portion and the second portion, wherein a first angle is included between the third portion and the first portion, and a second angle is included between the third portion and the second portion.

3. The frame structure of claim 1, further comprising a fixing structure combining the reflecting structure with the frame body.

4. The frame structure of claim 3, wherein the fixing structure further comprises at least one extending portion and at least one opening portion corresponding to the at least one extending portion, wherein the at least one extending portion is disposed on the first portion, and the at least one opening portion is disposed on the frame body.

5. The frame structure of claim 4, wherein the at least one extending portion has a rounded corner.

6. The frame structure of claim 3, wherein the fixing structure comprises a plurality of positioning posts and a plurality of penetrating hole portions corresponding to the positioning posts, wherein the positioning posts are disposed on one of the first potion and the frame, and the penetrating hole portions are disposed on the other one of the first potion and the frame.

7. The frame structure of claim 2, wherein the reflecting structure further comprises a plurality of microstructures respectively disposed on a surface of the first portion, a surface of the second portion and a surface of the third portion.

8. The frame structure of claim 2, wherein the first angle is substantially equal to the second angle.

9. A backlight module, comprising:
a back plate;
a light guide plate disposed on the back plate;
a light source which is disposed on the back plate and is adjacent to the light guide plate;
a frame body adapted to be disposed above the back plate; and
a reflecting structure which is disposed inside the frame body and covers the light source, wherein the reflecting structure comprises:
a first portion connected to the frame body; and
a second portion which is elastically separated from the frame body such that the second portion resiliently recovers and abuts against the light guide plate by elastic force.

10. The backlight module of claim 9, wherein the second portion and the first portion are at different elevations, wherein the reflecting structure further comprises a third portion connecting the first portion and the second portion, wherein a first angle is included between the third portion and the first portion, and a second angle is included between the third portion and the second portion.

11. The backlight module of claim 9, further comprising a fixing structure combining the reflecting structure with the frame body.

12. The backlight module of claim 9, wherein the light guide plate comprises a light-incident surface, and the second portion of the reflecting structure abuts against the light guide plate near the light-incident surface.

13. The backlight r nodule of claim 9, wherein the second portion elf the reflecting structure has a reflecting surface.

14. The backlight module of claim 9 wherein the frame body is movable in an unassembled state along a first direction to be disposed above the back plate in an assembled state, and the reflecting structure is movable in an unassembled state along a second direction to be disposed inside the frame body in an assembled state.

15. The backlight module of claim 9, wherein the frame body is movable in an unassembled state along a first direction until the reflecting structure disposed on the, frame body abuts against the light guide plate in an assembled state.

16. The backlight module of claim 11, wherein the fixing structure further comprises at least one extending portion and at least one opening portion corresponding to the at least one extending portion, wherein the at least one extending portion is disposed on the first portion, and the at least one opening portion is disposed on the frame body.

17. The backlight module of claim 16, wherein the at leas one extending portion has a rounded corner.

18. The backlight module of claim 11, wherein the fixing structure comprises a plurality of positioning posts and a plurality of hole portions corresponding to the positioning posts, wherein the positioning posts are disposed on one of the first potion and the frame, and the hole portions are disposed on the other one of the first potion and the frame.

19. The backlight module of claim 10, wherein the reflecting structure further comprises a plurality of microstructures respectively disposed on a surface of the first portion, a surface of the second portion and a surface of the third portion.

20. The backlight module of claim 10, wherein the first angle substantially equal to the second angle.
